(19) United States
(12) Patent Application Publication
(10) Pub. No.: US 2021/0175643 A1
(43) Pub. Date: Jun. 10, 2021

(54) CONDUCTIVE CELL FRAME

(71) Applicant: STL Technology Co., Ltd., Kaohsiung City (TW)

(72) Inventor: Cooper Chang, Kaohsiung City (TW)

(21) Appl. No.: 16/874,563

(22) Filed: May 14, 2020

(30) Foreign Application Priority Data
Dec. 4, 2019 (CN) 201911230190.5

(51) Int. Cl. H01R 4/62; H01M 2/20; H01R 11/09

(52) U.S. Cl. CPC H01R 4/625; H01M 2/206; H01R 43/0214; H01R 11/09; H01M 2/204

(57) ABSTRACT

A conductive cell frame for connecting a plurality of battery cells is disclosed. The conductive cell frame includes a first conductive portion and a plurality of second conductive portions, and the upper surface of each second conductive portion is connected to the first conductive portion through a eutectic portion. The lower surface of each second conductive portion is provided with at least one protruding welding portion, wherein the second conductive portion is connected to the housing of the battery cell through the protruding welding portion. The first conductive portion and the second conductive portion are made of different materials, wherein the resistance of the second conductive portion is greater than the resistance of the first conductive portion. Thus, a small current can be used to connect to the conductive cell frame and the battery cell, which not only reduces the consumption of energy, but also avoids damage of the battery cell during the electric welding process

### REFERENCE TO RELATED APPLICATIONS

This non-provisional application claims priority claim under 35 U.S.C. § 119(a) on China Patent Application No. 201911230190.5 filed Dec. 4, 2019 the entire contents of which are incorporated herein by reference.

### TECHNICAL FIELD

The present disclosure relates to a conductive cell frame for connecting battery cells, more particularly, to a conductive cell frame that prevents the battery cell from being damaged during connecting process.

### BACKGROUND

Examples of secondary cells include nickel-metal hydride (NiMH) batteries, nickel-cadmium (NiCd) batteries, lithium-ion (Li-ion) batteries, and lithium-ion polymer (Li-Poly) batteries, wherein lithium-ion batteries have advantages like high energy density, high operation voltage, wide utility temperature range, no memory effect, long battery life, capable of being charged/discharged numerous times and so on. Lithium-ion batteries are widely used in portable electronics such as cellular phones, laptop computers, and digital cameras, and even expanded its usage to the automobile industry in recent years.

A battery cell is mainly composed of anode material, electrolyte, cathode material, separator and housing, wherein the separator separates the anode material and the cathode material to prevent short-circuit and the electrolyte is disposed in the porous separator for conducting ionic charge. The housing wraps the anode material, the separator, the electrolyte, and the cathode material inside, and is usually made of metal materials in general.

A conductive cell frame is often used for connecting a plurality of battery cells in series and/or in parallel to form a battery pack that is capable of outputting a voltage required by a product. Generally, the conductive cell frame and the battery cell are connected by electric welding, during which the temperatures of the conductive cell frame and the battery cell need to be raised and the conductive cell frame applies force or pressure onto the housing at the anode or cathode of the battery cell to complete the connection between the conductive cell frame and the battery cell. However, in the connecting process of the conductive cell frame and the battery cell as mentioned above, the housing of the battery cell is likely to be damaged due to over force or overheat, and in turn the battery cell is damaged.

### SUMMARY

An object of the present disclosure is to provide a conductive cell frame that includes a first conductive portion and a plurality of second conductive portions, wherein the first conductive portion is connected to the second conductive portion through a eutectic portion. The first conductive portion and the second conductive portion are made of different metal materials, wherein a resistance of the second conductive portion is greater than a resistance of the first conductive portion. Through the implementation of the conductive cell frame of the present disclosure, energy consumption during electric welding process of the conductive cell frame and the battery cell is decreased and damages to the battery cell structure is reduced as well. Hence, the product yield and reliability are enhanced.

An object of the present disclosure is to provide a conductive cell frame that mainly includes a first conductive portion and a plurality of second conductive portions, wherein the second conductive portion is completely overlapped by the first conductive portion and formed a projection/bulge on the surface of the first conductive portion. The conductive cell frame is connected to the battery cell through the second conductive portion, wherein a gap is formed between the first conductive portion and the battery cell such that the electrolyte gas (gas of battery fluid) ejected from a bad battery cell can be expelled through the gap. Thus, the possibility of the electrolyte gas coming in contact with the conductive cell frame or other battery cells is reduced and so are the damages that may be caused therefrom.

An object of the present disclosure is to provide a conductive cell frame for connecting a plurality of battery cells in series and/or in parallel, wherein the battery cell includes an anode, a cathode and an insulation ring for isolating the cathode and the anode. The conductive cell frame is connected to the anode of the battery cell through a second conductive portion, wherein the cross-sectional area of the second conductive portion is smaller than the cross-sectional area of the anode or the encircled region formed by the insulation ring.

An object of the present disclosure is to provide a conductive cell frame that includes a first conductive portion, a plurality of eutectic portions, a plurality of conductive portions, and at least one protruding welding portion. The second conductive portion includes a first surface and a second surface, wherein the first surface of the second conductive portion is connected to the first conductive portion through the eutectic portion. The at least one protruding welding portion is disposed on the second surface of the second conductive portion and is used for connecting to a battery cell. The first conductive portion and the second conductive portion are of different materials, and the resistance of the second conductive portion is greater than the resistance of the first conductive portion.

Preferably, the second conductive portion includes at least one recess portion disposed on the first surface of the second conductive portion and the location of the recess portion corresponds to the location of the protruding welding portion.

Preferably, the second conductive portion and the first conductive portion are partially overlapped.

Preferably, the first conductive portion and the protruding welding portion on the second conductive portion are not overlapped.

Preferably, the second conductive portion is completely overlapped by the first conductive portion and formed a bulge on a surface of the first conductive portion to create a gap between the first conductive portion and the battery cell connected to the protruding welding portion.

Preferably, the battery cell includes an insulation ring for separating an anode and a cathode of the battery cell and the insulation ring has an encircled region in which the anode of the battery cell is located, and the cross-sectional area of the second conductive portion is smaller than or equal to the cross-sectional area of the anode or the encircled region of the insulation ring.

Preferably, the second conductive portion includes at least one recess portion disposed on the first surface of the second conductive portion and the location of the recess portion corresponds to the location of the protruding welding portion. The eutectic portion is connected to the first surface and the recess portion of the second conductive portion.

Preferably, the first conductive portion includes a plurality of branches respectively connected to the plurality of second conductive portions.

Preferably, the first conductive portion includes a plurality of branches, and each branch includes a plurality of sub-branches and is connected to one of the second conductive portions through the sub-branches.

Preferably, the thickness or the cross-sectional area of the second conductive portion is smaller than the thickness or the cross-sectional area of the first conductive portion.

### BRIEF DESCRIPTION OF THE DRAWINGS

The structure as well as preferred modes of use, further objects, and advantages of this present disclosure will be best understood by referring to the following detailed description of some illustrative embodiments in conjunction with the accompanying drawings, in which:

FIG. 1 is a top view of a conductive cell frame according to an embodiment of the present disclosure.

FIG. 2 is a side view of a conductive cell frame and a battery cell according to an embodiment of the present disclosure.

FIG. 3 is a side view of a conductive cell frame connected with a battery cell according to an embodiment of the present disclosure.

FIG. 4 is a top view of a conductive cell frame according to another embodiment of the present disclosure.

FIG. 5 is a top view of a conductive cell frame according to yet another embodiment of the present disclosure.

FIG. 6 is a side view of a conductive cell frame and a battery cell according to yet another embodiment of the present disclosure.

FIG. 7 is a side view of a conductive cell frame connected with a battery cell according to yet another embodiment of the present disclosure.

FIG. 8 is a top view of a conductive cell frame according to yet another embodiment of the present disclosure.

### DETAILED DESCRIPTION OF THE PREFERRED EMBODIMENTS

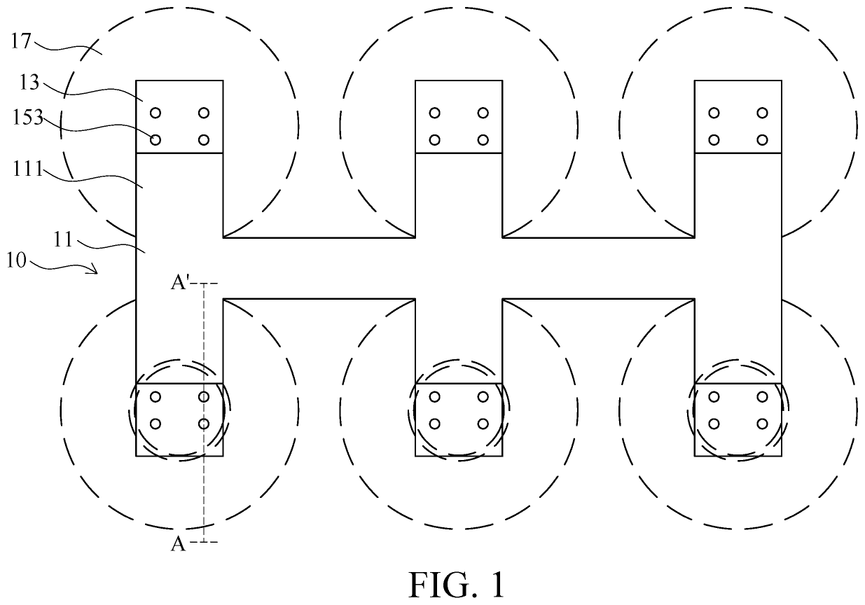

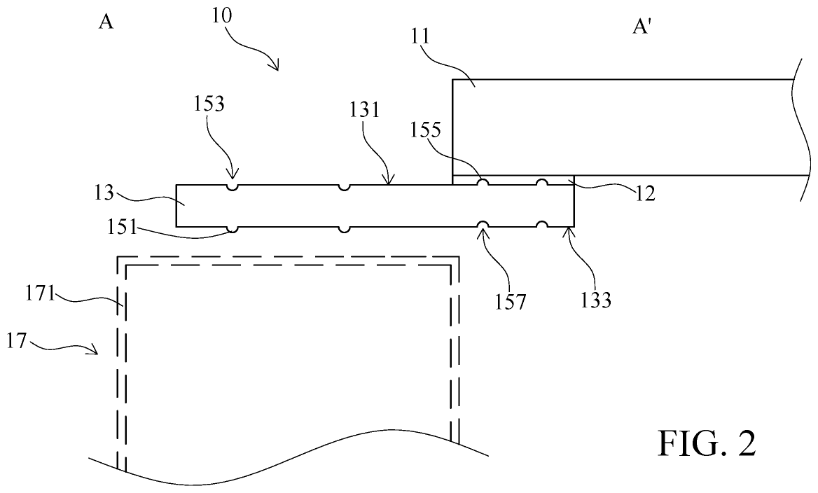

Referring to FIGS. 1 and 2, which are respectively a top view and a side view of a conductive cell frame according to an embodiment of the present disclosure, the conductive cell frame 10 includes a first conductive portion 11, at least one second conductive portion 13 and at last one protruding welding portion 151, wherein the first conductive portion 11 and the second conductive portion 13 are made of different materials and are connected through/joined by a eutectic portion 12. In other words, there are a plurality of eutectic portions 12 as one eutectic portion 12 corresponds to one connection/joint between the first conductive portion 11 and the second conductive portion 13.

The second conductive portion 13 includes a first surface 131 and a second surface 133, which can be, for example, two opposite surfaces on the second conductive portion 13, wherein parts of the first surface 131 of the second conductive portion 13 is connected to/joined with the first conductive portion 11 through the eutectic portion 12, and thus the main structure of the conductive cell frame 10 is formed. The first conductive portion and the second conductive portion are connected or joined by processes like welding.

In one embodiment, at least one protruding welding portion 155 is disposed on the first surface 131 of the second conductive portion 13, wherein the protruding welding portion 155 can be a bump or projection protruding from the first surface 131 of the second conductive portion 13, and the second conductive portion 13 is connected/joined to the first conductive portion 11 through the protruding welding portion 155. In practice, the first conductive portion 11 and the second conductive portion 13 are connected/joined by resistance welding process, where the protruding welding portion 155 on the first surface 131 of the second conductive portion 13 is placed/put in contact with the lower surface of the first conductive portion 11 and electric current is passed to the second conductive portion 13 through the first conductive portion 11, thereby raising the temperature of the protruding welding portion 155 on the second conductive portion 13 and the temperature of the first conductive portion 11 in contact therewith, and forming the eutectic portion 12 between the first conductive portion 11 and the second conductive portion 13.

Moreover, at least one protruding welding portion 151 is disposed on the second surface 133 of the second conductive portion 13, wherein the protruding welding portion 151 is a bump/projection protruding from the second surface 133 of the second conductive portion 13. Through the protruding welding portion 151, the second conductive portion 13 is connected to a housing 171 of a battery cell 17, and for example, connected to the anode or the cathode of the housing 171.

In one embodiment, the protruding welding portions 155/151 are formed respectively on the first surface 131 and the second surface 135 of the second conductive portion 13 by stamping or pressing processes, and at least one recess portions 157/153 are respectively formed on the second surface 133 and the first surface 131 of the second conductive portion 13, wherein the location of the recess portion 157/153 corresponds to the location of the protruding welding portion 155/151.

It is to be noted that making the second conductive portion 13 by stamping/pressing process is merely an embodiment of the present disclosure, and the scope of the present disclosure is not limited thereby. Thus, the present disclosure is not limited to the first surface 131 and the second surface 133 of the second conductive portion 13 having at least one recess portion 153/157 thereon. In practice, the second conductive portion 13 can be made by other methods, such as casting, and so there won't be any recess portion 153/157 on the first surface 131 and the second surface 133 of the second conductive portion 13.

In one embodiment, the second conductive portion 13 and the first conductive portion 11 are partially overlapped, wherein the first conductive portion 11 and the protruding welding portion 151 and/or the recess portion 153 on the second conductive portion 13 are not overlapped. Specifically, the protruding welding portion 151 and/or the recess portion 153 are disposed on the region of the second conductive portion 13 that is not overlapped with the first conductive portion 11, so that the eutectic portion 12 that connects/joins the first conductive portion 11 and the second conductive portion 13 is not in contact with or does not touch the recess portion 153 of the second conductive portion 13.

In practice, welding, which is a technique that joins different metals by using high heat or high pressure, is mainly used to connect/join the second conductive portion 13, the protruding welding portion 151, and the housing 171 of the battery cell 17.

In one embodiment, the second conductive portion 13, the protruding welding portion 151, and the housing 171 of the battery cell 17 are connected/joined by resistance welding process. First, the protruding welding portion 151 on the second conductive portion 13 is placed/put in contact with the battery cell 17, for example, in contact with the housing 171 at where the anode or the cathode of the battery cell 17 is, wherein the housing 171 is of a metal material.

Next, electric current is supplied to the second conductive portion 13, the protruding welding portion 151 and the housing 171 of the battery cell 17, all of which are made of metal materials and have electrical resistances, and therefore when the electric current passes through the second conductive portion 13, the protruding welding portion 151 and the housing 171 of the battery cell 17, there is an increase in the temperature of the protruding welding portion 151 and the temperature of the housing 171 of the battery cell 17 in contact therewith.

When the temperatures of the second conductive portion, the protruding welding portion 151 and the housing 171 of the battery cell 17 reach a specific value, a pool of molten material, or a weld pool, is formed. Force or pressure is then applied onto the housing 171 of the battery cell 17 through the second conductive portion 13 and the protruding welding portion 151 such that the protruding welding portion 151 on the second conductive portion 13 is pressed and sunk into the housing 171 of the battery cell 17. After the temperatures of the second conductive portion 13, the protruding welding portion 151 and the housing 171 of the battery cell 17 cooled down, the connection between the second conduction portion 13 and the battery cell 17 is complete.

In general, conductive cell frames are often made of materials with low resistance and high conductivity to reduce the energy loss from charging and discharging the battery cell through the conductive cell frame. When connecting a conductive cell frame having low resistance and the housing of the battery cell in contact by resistance welding, a greater electric current must be supplied to the conductive cell frame and the housing of the battery cell, and the energy consumption of welding the conductive cell frame and the battery cell is high.

Moreover, such conductive cell frame usually has a thicker thickness for increasing the cross-sectional area of the conductive cell frame so as to reduce the resistance of the conductive cell frame. But as the thickness of the conductive cell frame increases, the structural strength of the conductive cell frame is also enhanced, making the conductive cell frame harder to deform when connecting to the housing of the battery cell. Thus, when the conductive cell frame applies force or pressure onto the housing of the battery cell, the housing of the battery cell has a greater deformation. For example, the protruding welding portion on the conductive cell frame would make a deeper or wider cavity in the housing of the battery cell.

Hence, the housing structure of the battery cell could be damaged during the connecting process of the conductive cell frame and the battery cell and the reliability and durability of the battery cell is thus affected. The damage to the housing is, for example, formation of metal cracks on the housing of the battery cell. However, if a conductive cell frame with high resistance and low conductivity is selected in attempt to avoid the aforementioned issue occurred in welding the conductive cell frame to the battery cell, the energy loss from the charging and discharging of the battery cell through the conductive cell frame will increase.

To solve the aforementioned issue, the present disclosure provides the conductive cell structure 10 that is made by two different materials, wherein the first conductive portion 11 and the second conductive portion 13 are of different materials, and the resistance and/or the resistivity of the second conductive portion 13 is greater than that of the first conductive portion 11. In other words, the conductivity of the first conductive portion 11 is higher than the conductivity of the second conductive portion 13. The first conductive portion 11 is copper and the second conductive portion 13 is nickel, for example.

Since the second conductive portion 13 has a greater resistance, a small or lower current can be supplied to the second conductive portion 13 when connecting the second conductive portion 13 of the conductive cell frame 10 and the contacted housing 171 of the battery cell 17. Therefore, resistance welding process can be used to connect/join the second conductive portion 13 and the housing 171 of the battery cell 17 so as to effectively reduce the energy consumed during the connecting/joining process of the conductive cell frame 10 and the battery cell 17.

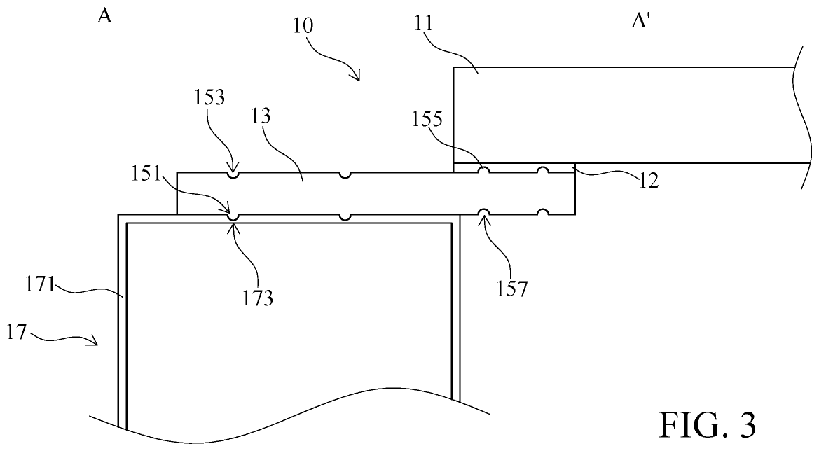

Furthermore, the thickness of the second conductive portion 13 is reduced to lessen the structural strength of the second conductive portion 13. In one embodiment, the thickness or the cross-sectional area of the second conductive portion 13 is smaller than the thickness or the cross-sectional area of the first conductive portion 11. When connecting/joining the second conductive portion 13 with the housing 171 of the battery cell 17 by resistance welding, both the second conductive portion 13 and the housing 17 of the battery cell 17 would deform so as to reduce the degree of deformation on the housing 171 of the battery cell 17. As shown in FIG. 3, the protruding welding portion 151 on the second conductive portion 13 deforms during the resistance welding process and the thickness and/or area of a deformed portion 173 caused by the protruding welding portion 151 forcing/pressing on the housing 171 of the battery cell 17 is reduced. Hence, damages to the housing structure 171 of the battery cell 17, like formation of metal cracks on the housing 171 of the battery cell 17, can be avoided during the connecting/joining process of the conductive cell frame 10 and the battery cell 17, and the durability and reliability of the battery cell 17 are enhanced.

In addition, since the first conductive portion 11 has a lower resistance value, there is no substantial increase in the resistance value of the conductive cell frame 10 with the addition of the second conductive portion 13, and so the energy loss caused by the conductive cell frame 10 charging and discharging the battery cell 17 is reduced.

In the embodiment shown in FIG. 1, the first conductive portion 11 looks like a fishbone and has a plurality of branches 111, wherein each of the branches 111 of the first conductive portion 11 is connected to one of the second conductive portions 13 through the eutectic portion 12. For example, the first conductive portion 13 in FIG. 1 includes six branches 111 and through the six branches 111 is connected to six second conductive portions 13, wherein each of the six conductive portions 13 is connected to one battery cell 17, and so the conductive cell frame 10 connects the six battery cells 17 in series and/or in parallel.

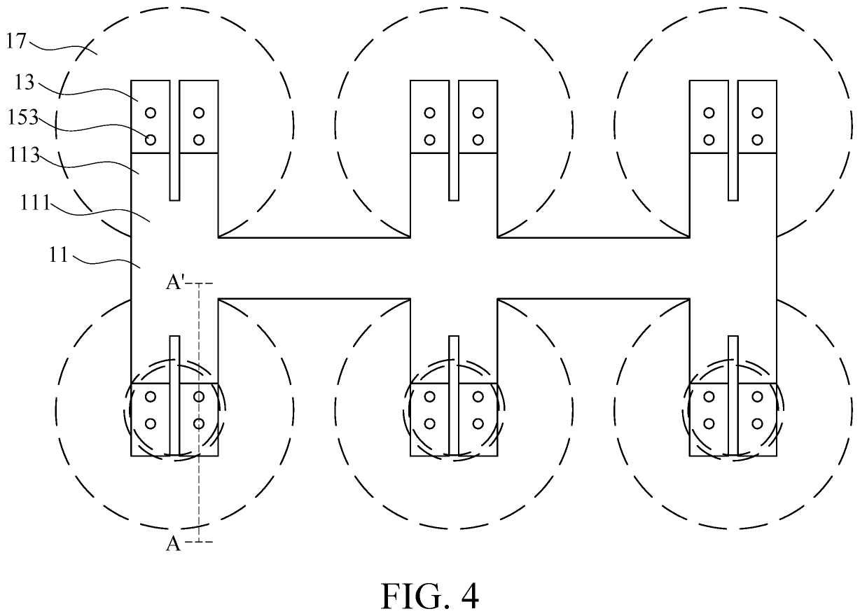

In another embodiment shown in FIG. 4, each branch 11 of the first conductive portion 11 has a plurality of sub-branches 113 disposed thereto, wherein each of the sub-branches 113 is connected to one of the second conductive portions 13, such that each branch 111 of the first conductive portion 11 is connected to plurality of second conductive portions 13. For example, the first conductive portion 11 in FIG. 4 includes six branches 111, wherein each branch 111 is connected to two sub-branches 113 and each sub-branch 113 is connected to one second conductive portion 13, such that each branch 111 is connected to one battery cell 17 through two second conductive portions 13.

It is to be noted that the present disclosure does not limit the number of the branches 111 and the sub-branches 113 of the first conductive portion 11 and the number of the second conductive portions 13 and the battery cells 17 connected to the first conductive portion 11.

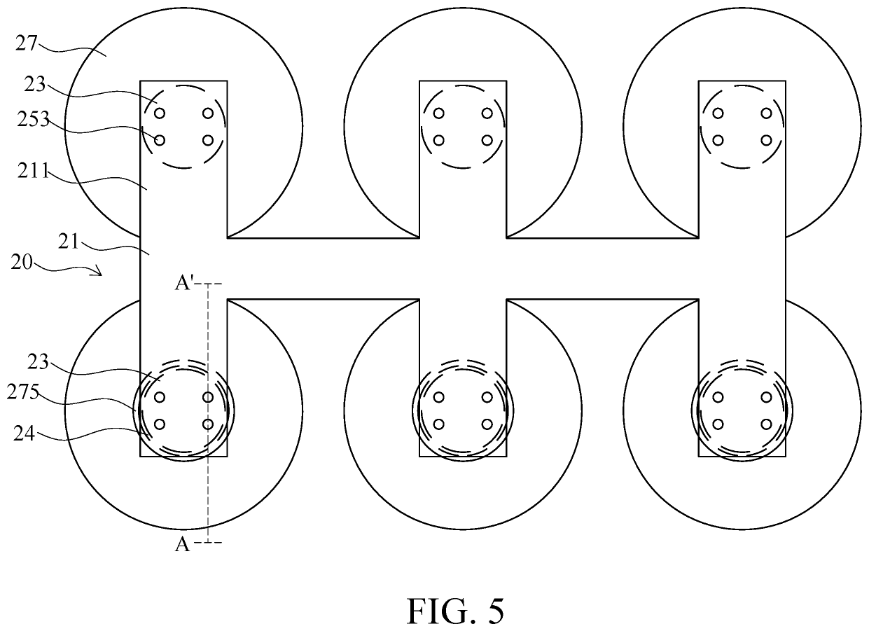

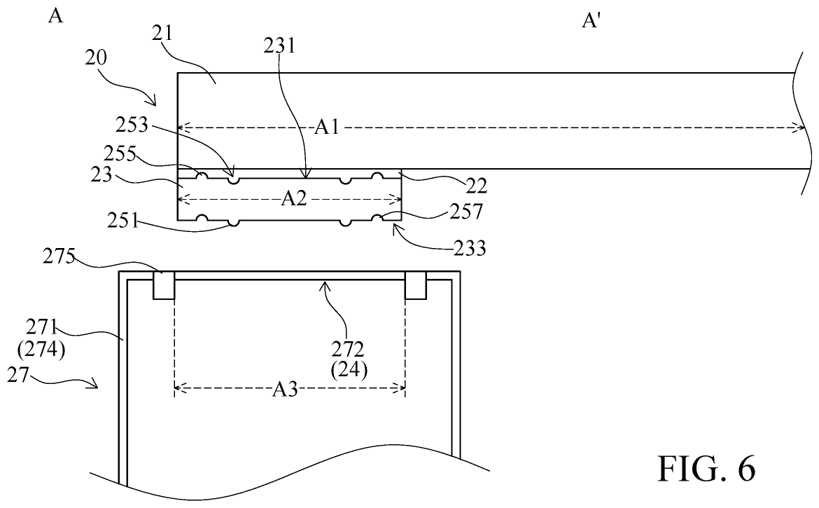

Referring to FIGS. 5 and 6, which are respectively a top view and a side view of a conductive cell frame according to another embodiment of the present disclosure, the conductive cell frame 20 includes, mainly, a first conductive portion 21, at least one second conductive portion 13 and at least one protruding welding portion 251, wherein the first conductive portion and the second conductive portion 23 are made of different materials and are connected through/joined by a eutectic portion 22. In other words, there is at least one eutectic portion 22 as one eutectic portion 22 corresponds to one connection/joint between the first conductive portion 21 and the second conductive portion 23.

Particularly, the second conductive portion 23 includes a first surface 231 and a second surface 233, wherein the first surface 231 of the second conductive portion 23 is connected to/joined with the first conductive portion 21 through the eutectic portion 22 and thus the main structure of the conductive cell frame 20 is formed.

In one embodiment, at least one protruding welding portion 255 is disposed on the first surface 231 of the second conductive portion 23, wherein the protruding welding portion 255 is a bump/projection that protrudes from the first surface 231 of the second conductive portion 23, and the second conductive portion 23 is connected to/joined with the first conductive portion 21 through the protruding welding portion 255. In practice, the first conductive portion 21 and the second conductive portion 23 are connected/joined by resistance welding, where the protruding welding portion 255 on the first surface 231 of the second conductive portion 23 is placed/put in contact with the lower surface of the first conductive portion 21, and by supplying electric current to the second conductive portion 23 through the first conductive portion 21, the temperatures of the protruding welding portion 255 and the contacted first conductive portion 21 are raised and the eutectic portion 22 is formed between the first conductive portion 21 and the second conductive portion 23.

In one embodiment shown in FIG. 6, the cross-sectional area A2 of the second conductive portion 23 is smaller than the cross-sectional area A1 of the first conductive portion 21, wherein the second conductive portion 23 is completely/fully overlapped by the first conductive portion 21, like the entire first surface 231 and/or second surface 233 of the second conductive portion 23 is overlapped by the first conductive portion 21, and formed a bulge on the surface of the first conductive portion 21. After the second conductive portion 23 is connected to/joined with the first conductive portion through the eutectic portion 22, the second conductive portion 23 forms a bulged conductive portion on the surface, such as the lower surface, of the first conductive portion 21.

At least one protruding welding portion 251 is disposed on the second surface 233 of the second conductive portion 23, wherein the protruding welding portion 251 is a bump/projection that protrudes from the second surface 233 of the second conductive portion 23, and at least one recess portion 253 is disposed on the first surface 231 of the second conductive portion 23, wherein the location of the recess portion 253 corresponds to the location of the protruding welding portion 251. In other embodiments, there is no recess portion 253 disposed on the first surface 231 of the second conductive portion 23.

Since the second conductive portion 23 is completely/fully overlapped by the first conductive portion 21, the protruding welding portion 251 and/or the recess portion 253 on the second conductive portion 23 also overlaps with the first conductive portion 21. When the first surface 231 of the second conductive portion 23 has the recess portion 253 thereon, the eutectic portion 22 connecting/joining the first conductive portion 21 and the second conductive portion 23 is only formed on the first surface 231 of the second conductive portion 23, wherein there is no eutectic portion 22 in the recess portion 253. In other embodiments, the eutectic portion 22 is formed both on the first surface 231 and in the recess portion 253 of the second conductive portion 23; in other words, the eutectic portion 22 is connected to the first surface 231 and the recess portion 253.

In one embodiment, the second conductive portion 23, the protruding welding portion 251 and the housing 271 of the battery cell 27 are connected/joined by resistance welding so as to complete the connection between the second conductive portion 23 and the battery cell 27. The conductive cell frame 20 is made of two different materials, wherein the resistance and/or the resistivity of the second conductive portion 23 is greater than that of the first conductive portion 21. In other words, the conductivity of the first conductive portion 21 is greater than that of the second conductive portion 23. The first conductive portion 21 is copper and the second conductive portion 23 is nickel, for example.

Therefore, when connecting the conductive cell frame 20 and the contacted battery cell 27 by resistance welding, the electric current supplied from the first conductive portion 21 to the second conductive portion 23 and the housing 271 of the battery cell 27 can be lowered and so the energy consumption of connecting the conductive cell frame 20 and the battery cell is effectively reduced.

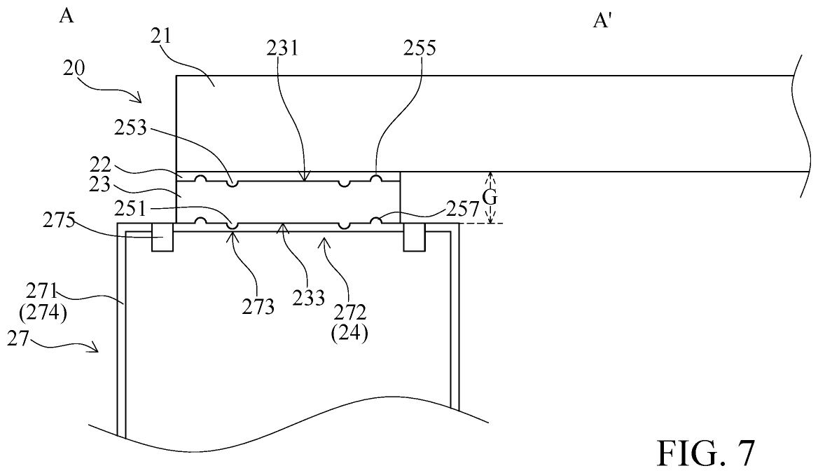

Moreover, the thickness of the second conductive portion 23 is decreased and the structural strength of the second conductive portion 23 is thereby lessened, such that the protruding welding portion 251 on the second conductive portion 23 also deforms during the resistance welding process. Therefore, the depth or area of the deformed portion 273 caused by the force or pressure applied by protruding welding portion 251 on the housing 271 of the battery cell 27 is reduced as shown in FIG. 7 and the damages to the housing structure of the battery cell 27 during connecting process is avoided.

In the embodiment shown in FIG. 5, the first conductive portion 21 has a fishbone-like appearance that includes a plurality of branches 211, and each branch 211 of the first conductive portion 21 is connected to one second conductive portion 23 through the eutectic portion 22, wherein each second conductive portion 23 is completely overlapped by the branch 211 of the first conductive portion 21 which it connected to.

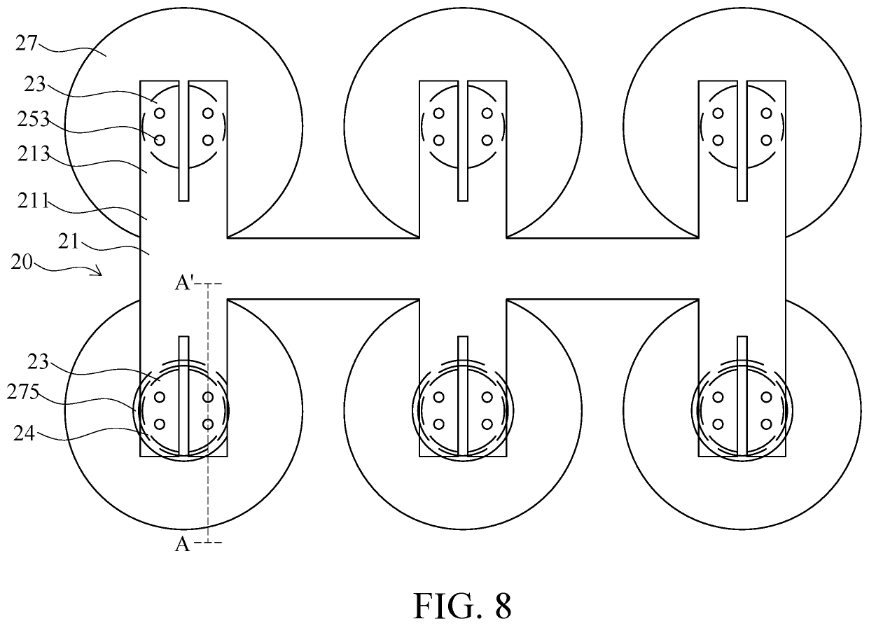

In another embodiment, as shown in FIG. 8, each branch 211 of the first conductive portion 21 is connected to a plurality of sub-branches 213, wherein each of the sub-branches 213 is connected to one of the second conductive portions 23, such that each branch 211 of the first conductive portion 21 is connected to plurality of second conductive portions 23 and is connected to a battery cell 27 through the plurality of second conductive portions 23.

It is to be noted that the present disclosure does not limit the number of the branches 211 and the sub-branches on the first conductive portion 21 and the number of the second conductive portions 23 and the battery cells 27 connected to the first conductive portion 21.

Since the second conductive portion 23 is completely overlapped by the first conductive portion 21 and protrudes from the surface, like the lower surface, of the first conductive portion 21, a gap G as shown in FIG. 7 is formed/created between the first conductive portion 21 and the connected battery cell 27 when the conductive cell frame 20 is connected to the housing 271 of the battery cell 27 through the second conductive portion 23. If the battery cell 27 is damaged and ejects electrolyte gas (gas of battery fluid), the ejected electrolyte gas is expelled through the gap G between the first conductive portion 21 and the battery cell 27, whereby the possibility or the length of time which the electrolyte gas comes in contact with the conductive cell frame 20 and/or other battery cells 27 is reduced and so the damages of other battery cells 27 is minimized.

In one embodiment, the battery cell 27 includes an anode 272, a cathode 274 and an insulation ring for separating the anode 272 and the cathode 274. More specifically, the insulation ring 275 forms an encircled region 24, wherein the anode 272 of the battery cell 27 is located inside the encircled region 24 of the insulation ring 275, and the area of the anode 272 is smaller than or equal to the area of the encircled region 24. The cathode 274 is located outside of encircled region 24, external of the insulation ring 275.

In one embodiment, the cross-sectional area A2 of the second conductive portion 23 is smaller than or equal to the cross-sectional area A3 of the encircled region 24 inside the insulation ring 275. In other words, the cross-sectional area A2 of the second conductive portion 23 is smaller than or equal to the cross-sectional area A3 of the anode 272 in the battery cell 27. When the conductive cell frame 20 is connected to the anode of the battery cell 27, only the second conductive portion 23 is in contact with the anode located in the insulation ring 275.

Generally, when the battery cell 27 is damaged, the gas of battery fluid inside the battery cell 27 usually would eject out of the battery cell 27 from the insulation ring 275 which is the boarder between the anode 272 and the cathode 274. In this embodiment, because the second conductive portion 23 only connects to the anode 272 inside the insulation ring 275 and there is the gap G between the first conductive portion 21, the insulation ring 275 and the housing 271 of the battery cell 27, the gas of battery fluid ejected from the battery cell 27 is expelled to the outside through the gap G.

The above disclosure is only the preferred embodiment of the present disclosure, and not used for limiting the scope of the present disclosure. All equivalent variations and modifications on the basis of shapes, structures, features and spirits described in claims of the present disclosure should be included in the claims of the present disclosure.

1. A conductive cell frame comprising:
a first conductive portion;
a plurality of eutectic portions;
a plurality of second conductive portions, each the second conductive portion comprising a first surface and a second surface, wherein the first surface of the second conductive portion is connected to the first conductive portion through the eutectic portion; and
at least one protruding welding portion disposed on the second surface of the second conductive portion for connecting to a battery cell;
wherein the first conductive portion and the second conductive portion are of different materials and a resistance of the second conductive portion is greater than a resistance of the first conductive portion.

2. The conductive cell frame of claim 1, wherein the second conductive portion comprises at least one recess portion disposed on the first surface of the second conductive portion and a location of the recess portion corresponds to a location of the protruding welding portion.

3. The conductive cell frame of claim 1, wherein the second conductive portion and the first conductive portion are partially overlapped.

4. The conductive cell frame of claim 3, wherein the first conductive portion and the protruding welding portion on the second conductive portion are not overlapped.

5. The conductive cell frame of claim 1, wherein the second conductive portion is completely overlapped by the first conductive portion to form a bulge on a surface of the first conductive portion to create a gap between the first conductive portion and the battery cell connected to the protruding welding portion.

6. The conductive cell frame of claim 5, wherein the battery cell comprises an insulation ring to isolate an anode and a cathode of the battery cell, the insulation ring comprises an encircled region, the anode of the battery cell is located in the encircled region, and a cross-sectional area of the second conductive portion is smaller than or equal to a cross-sectional area of the encircled region of the insulation ring or a cross-sectional area of the anode.

7. The conductive cell frame of claim 5, wherein the second conductive portion comprises at least one recess portion disposed on the first surface of the second conductive portion, a location of the recess portion corresponds to a location of the protruding welding portion, and the eutectic portion is connected to the first surface and the recess portion of the second conductive portion.

8. The conductive cell frame of claim 1, wherein the first conductive portion comprises a plurality of braches respectively connected to the plurality of second conductive portions.

9. The conductive cell frame of claim 1, wherein the first conductive portion comprises a plurality of branches, and each branch comprises a plurality of sub-branches and is connected to one of the second conductive portions through the plurality of sub-branches.

10. The conductive cell frame of claim 1, wherein a thickness or a cross-sectional area of the second conductive portion is smaller than a thickness or a cross-sectional area of the first conductive portion.
